(19) United States
(12) Patent Application Publication
(10) Pub. No.: US 2010/0157508 A1
(43) Pub. Date: Jun. 24, 2010

(54) METHOD OF MANUFACTURING COMPLEX OXIDE NANO PARTICLES AND COMPLEX OXIDE NANO PARTICLES MANUFACTURED BY THE SAME

(75) Inventors: Chul Tack Lim, Suwon (KR); Chang Hwan Choi, Seongnam (KR); Byoung Jin Chun, Suwon (KR); Jin Hyuck Yang, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/493,816

(22) Filed: Jun. 29, 2009

(30) Foreign Application Priority Data
Dec. 23, 2008 (KR) 10-2008-0132444

(51) Int. Cl. H01G 4/20; C08K 3/10; B05D 3/02

(52) U.S. Cl. 361/320; 524/413; 524/436; 524/437; 427/383.1; 427/380; 427/316; 361/321.2

(57) ABSTRACT

A method of manufacturing complex oxide nano particles includes preparing a mixed solution including at least one metal salt selected from the group consisting of aluminum salt, manganese salt and barium salt, impregnating an organic polymer having nano-sized pores with the mixed solution, and calcining the organic polymer impregnated with the mixed solution. Accordingly, complex oxides with particle sizes on the nanoscale can be prepared, and the kind and composition ratio of metal elements contained in the complex oxides can be facilitated. Also, a multilayer ceramic capacitor including the complex metal oxides manufactured by this method can ensure a super slim profile and high capacity.

### CROSS-REFERENCE TO RELATED APPLICATIONS

This application claims the priority of Korean Patent Application No. 2008-0132444 filed on Dec. 23, 2008, in the Korean Intellectual Property Office, the disclosure of which is incorporated herein by reference.

### BACKGROUND OF THE INVENTION

1. Field of the Invention

The present invention relates to a method of manufacturing complex oxide nano particles and complex oxide nano particles manufactured by the same, and more particularly, to a method of manufacturing complex oxide nano particles, which can prepare complex oxides, containing at least two kinds of metal elements, in the form of particles having sizes of tens of nanometers and precisely design the composite ratio of the metal elements, and complex oxide nano particles manufactured by the same.

2. Description of the Related Art

With the trend towards smaller and thinner electrical/electronic products with higher capacities, preparing raw materials into fine particles has become critical in the process of manufacturing electrical/electronic products.

For example, multilayer ceramic capacitors (MLCCs) are manufactured using barium titanate (BaTiO₃) as the main element of dielectric bodies, and additives, generally, metal oxides, which influence the characteristics of MLCCs. To increase electrostatic capacitance, the additives, as well as the BaTiO₃, need to be prepared as finer particles, uniformly dispersed as primary particles, and maintain their dispersed states stably.

As for high capacity, super slim MLCCs that commonly use BaTiO₃ having an average particles size of about 150 nm, the main components of dielectric bodies and additive powders need to be prepared as fine particles and dispersed stably. This is to coat BaTiO₃ particles desirably by adding additives, maintain the uniform compositions of internal electrodes and dielectric layers and prevent the creation of pores within dielectric bodies, thus achieving super slim profiles and high reliability.

Metal oxides containing magnesium (Mg), aluminum (Al), Vanadium (V), manganese (Mn), barium (Ba) or dysprosium (Dy) are employed as additives in manufacturing MLCCs. Magnesium oxide serves to prevent the excessive growth of basic particles, and vanadium oxide serves as an accelerant for low-temperature liquid-phase sintering. Rare earth oxides, such as Dy, reduce the mobility of oxygen, thus enhancing the long-term reliability of MLCCs. Even if the additives are used in small amounts, the characteristics of the additives, such as particle sizes or shapes, may affect the overall performance or quality of products considerably.

A top-down method may be used to manufacture fine metal oxide particles. In this top-down method, metal oxide precursors, having a primary average particle size of 100 nm to 2000 nm, are dispersed using dispersers to produce a slurry, and then milled into smaller-sized particles. That is, the top-down method involves milling powder with a greater particle size than a desired particle size in order to produce smaller particles.

The top-down method may produce particles of tens of nanometers in size according to the particle size of metal oxides, precursors, but is disadvantageous in that the precursors are expensive. Also, precursors with a large particle size are not easy to mill, and even if the precursors are milled, the resultant particles may not be properly shaped and may cohere again.

Of late, methods of separating precursors using an aerosol method or microwave plasma have been proposed to manufacture fine metal oxide particles. However, these methods are merely other types of top-down method adopting the principle of milling powder into smaller particles, and still have limitations in regulating particle sizes.

### SUMMARY OF THE INVENTION

An aspect of the present invention provides a method of manufacturing complex oxide nano particles, which can produce complex oxides, containing at least two kinds of metal oxides in the form of particles with an average size on the nanoscale, and allow the composition ratio of the metal oxides to be easily regulated, and complex oxide nano particles manufactured by the same.

According to an aspect of the present invention, there is provided a method of manufacturing complex oxide nano particles, including: preparing a mixed solution including at least one metal salt selected from the group consisting of aluminum salt, manganese salt and barium salt; impregnating an organic polymer having nano-sized pores with the mixed solution; and calcining the organic polymer impregnated with the mixed solution.

In the preparing of the mixed solution, the mixed solution may further include at least one metal salt selected from the group consisting of magnesium salt, vanadium salt and dysprosium salt.

A solvent of the mixed solution may be water or an organic solvent. The mixed solution may have a concentration in the range from 5 wt. % to 25 wt %.

The pores of the organic polymer may range from 1 nm to 9 nm in size.

The calcining of the organic polymer may be performed at a temperature ranging from 250° C. to 900° C.

The calcining of the organic polymer may be performed in two steps. The calcining of the organic polymer may be performed at a temperature of 250° C. to 350° C., and then at a temperature of 700° C. to 900° C.

The method may further include drying the organic polymer, before the calcining of the organic polymer impregnated with the mixed solution including the metal salt.

The method may further include milling remnants after the calcining of the impregnated organic polymer.

According to another aspect of the present invention, there is provided complex oxide nano particles manufactured by the method of manufacturing complex oxide nano particles.

According to another aspect of the present invention, there is provided a multilayer ceramic capacitor including: a plurality of dielectric layers each including a ceramic dielectric body and the complex oxide nano particles manufactured according to the present invention; internal electrodes alternated with the dielectric layers; and external electrode electrically connected to the internal electrode, respectively.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates metal salt particles trapped in the respective pores of an organic polymer according to an exemplary embodiment of the present invention;

FIG. 2 is a cross-sectional view of a multilayer ceramic capacitor (MLCC) according to an exemplary embodiment of the present invention;

FIGS. 3 and 4 are a field emission scanning electron microscope (FE-SEM) image and a graph depicting the particle-size distribution of complex oxide nano particles manufactured according to an exemplary embodiment of the present invention, respectively;

FIGS. 5 and 6 are an FE-SEM image and a graph depicting the result of particle-size analysis of metal oxide nano particles according to the related art, respectively; and

FIGS. 7 and 8 are graphs respectively depicting the dielectric constants and loss coefficients of MLCCs manufactured according to an exemplary embodiment of the present invention and the related art.

### DETAILED DESCRIPTION OF THE PREFERRED EMBODIMENT

Exemplary embodiments of the present invention will now be described in detail with reference to the accompanying drawings.

A method of manufacturing complex oxide nano particles includes: preparing a mixed solution including at least one metal salt selected from the group consisting of aluminum salt, manganese salt and barium salt; impregnating an organic polymer having nano-sized pores with the mixed solution; and calcining the organic polymer impregnated with the mixed solution.

In general, additives used in manufacturing multilayer ceramic capacitors (MLCCs) are prepared by milling metal oxides with a small particle size into smaller particles. However, as described above, this top-down method has limitations such as expensive precursors, uneven particle sizes, and a limited range of particle size control. The method of manufacturing complex oxide nano particles according to the present invention allows complex oxide nano particles with a nanoscale size to be prepared at low manufacturing costs by use of metal salts, and facilitates the control of the composition ratio of metal elements.

A method of manufacturing complex oxide nano particles according to the present invention will now be described in detail.

First, at least one metal salt selected from the group consisting of aluminum salt, manganese salt and barium salt is dissolved in a solvent. In this case, end complex oxide nano particles contain at least one metal oxide selected from the group consisting of the oxides of aluminum, manganese and barium.

The metal salt may be at least one selected from the group consisting of aluminum salt, manganese salt and barium salt, and may contain at least one of aluminum, manganese and barium. The solvent is not limited provided that it can dissolve the metal salt. For example, the solvent may be water or an organic solvent, and as for the organic solvent, ethanol may be used.

The concentration of a resultant mixed solution is not specifically limited but determined in due consideration of the pore characteristics of an organic polymer which is to be impregnated with the mixed solution. For example, the concentration of the mixed solution may range from 5 wt % to 25 wt %. A concentration of less than 5 wt % considerably lowers the yield of complex metal oxides, the end products, due to an insufficient amount of metal salts acting as precursors of complex metal oxide nano particles. Also, a concentration exceeding 25 wt % may result in the coherence of nano particles because a limited number of pores of the organic polymer do not correspond with the number of nano particles to be trapped therein.

To prepare the mixed solution, at least one metal salt selected from the group consisting of magnesium salt, vanadium salt and dysprosium salt may also be added. In this case, the final complex oxide nano particles may contain at least one metal oxide selected from the group consisting of the oxides of aluminum, manganese and barium, and at least one metal oxide selected from the group consisting of the oxides of magnesium, vanadium and dysprosium. In the method of manufacturing complex oxide nano particles according to the present invention, the composition of complex oxides used as additives for MLCCs may be regulated. That is, end complex oxides may be prepared with kinds of metal salts controlled depending on metal oxides which are to be added.

Also, in the method of manufacturing complex oxide nano particles according to the present invention, the composition ratio of metal oxides contained in end complex oxides may be regulated by controlling the amounts of metal salts included in the mixed solution.

Thereafter, an organic polymer having nano-sized pores is impregnated with the mixed solution containing the dissolved metal salts.

The organic polymer is not specifically limited, provided that it has nano-sized pores. For example, the organic polymer may have nano-sized pores as in pulp-type fiber tissues. The organic polymer may, for example, be cellulose from plants. The cellulose is represented by (C₆H₁₀O₆)ₙ, and is split into carbon dioxide (CO₂) and water (H₂O) when heated.

The term “nano-sized” in “nano-sized pores” refers to a few or tens of nanometers. The pores of the organic polymer may each have a diameter of 1 nm to 9 nm. The metal salts, the precursor of complex oxides, are trapped in the pores of the organic polymer. Here, the metal salts, before being converted into complex oxides, are trapped in the respective pores of the organic polymer, each being a few or tens of nanometers in size. Thereafter, the metal salts are converted into complex metal oxide particles of tens of nanometers in size.

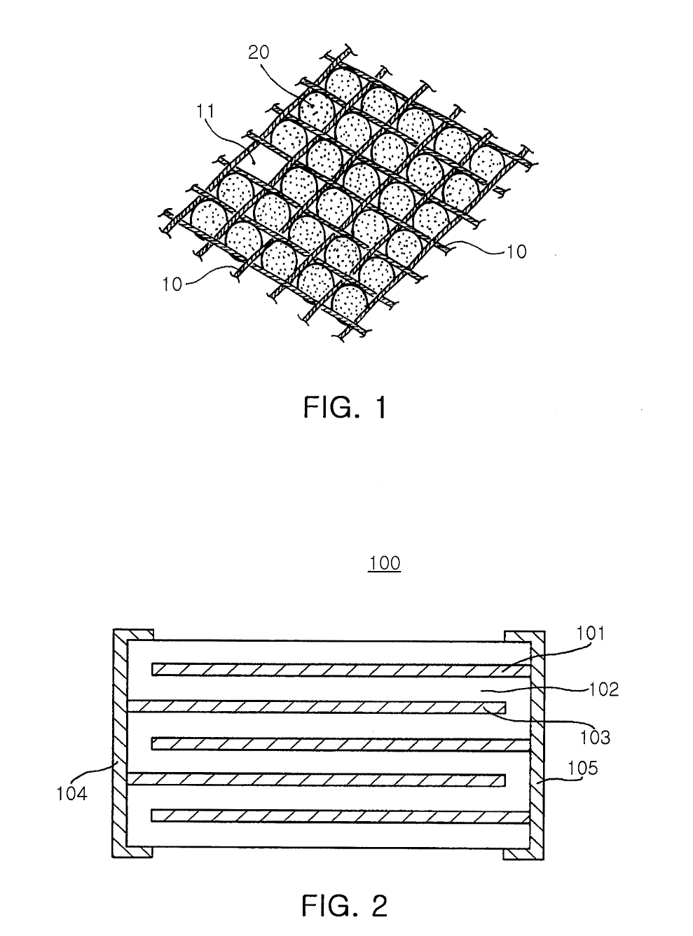

FIG. 1 illustrates metal salt particles 20 trapped in pores 11 of an organic polymer 10 respectively, according to an exemplary embodiment of the present invention. The invention may however be embodied in many different forms and should not be construed as limited to the embodiments set forth herein.

Referring to FIG. 1, the metal salt particles 20, trapped in the nano-sized pores 11 of the organic polymer 10 respectively, exist in the size of a few nanometers.

The metal salt particles 20 do not cohere at the time of reaction since each of the metal salt particles 20 is collected in a different pore 11 of the organic polymer 10. These precursors on the nanoscale allow complex oxides, which will be produced by a subsequent reaction, to have a size of tens of nanometers. Also, produced complex oxide particles may have uniform shapes.

Thereafter, the organic polymer impregnated with the mixed solution containing the metal salts is calcined. The calcination may be performed at a temperature ranging from 250° C. to 900° C., but is not limited thereto. If the organic polymer is cellulose represented by (C₆H₁₀O₆)ₙ, the cellulose may be split into CO₂ and H₂O and removed.

The calcination may be performed in two separate steps. For example, the calcination may be performed at a temperature of 250° C. to 350° C. and then at a temperature of 700° C. to 900° C.

The method of manufacturing complex oxide nano particles, according to an exemplary embodiment of the present invention, may further include drying the organic polymer impregnated with the metal-salt mixed solution before the calcination of the organic polymer impregnated with the mixed solution. If the organic polymer is impregnated with an excessive amount of metal salts, metal salts or metal crystals larger than the nanoscale may be produced on the surface of the organic polymer. Thus, an excessive amount of metal-salt mixed solution may be removed by use of a drying method or other methods.

The method of manufacturing complex metal oxide nano particles, according to an exemplary embodiment of the present invention, may further include a milling process after the calcination. The milling process is performed to obtain uniform-sized nano particles from the complex oxides having a size of tens of nanometers by the use of the organic polymer.

By the use of the milling process, the complex oxide nano particles may be adjusted to have a desired size and shape. Here, secondary particles may exist, which are formed by the coherence of primary particles. Therefore, a centrifugal separator may be used to remove the secondary particles and obtain just the primary particles, thus obtaining a more uniform particle-size distribution.

The complex oxide nano particles prepared by the above manner may have an average particle size of 60 nm or less. In the related art method of mixing, heating and milling metal oxide nano particles, it is difficult to prepare nano particles with a particle size of 100 nm or less. However, the method of manufacturing complex oxide nano particles according to the present invention allows the preparation of finer particles and improves the distribution characteristics thereof. Accordingly, nano particles of 60 nm or less in size can be manufactured even when solid exists at 100 or more.

A multilayer ceramic capacitor (MLCC) according to an exemplary embodiment of the present invention includes: a plurality of dielectric layers including ceramic dielectric bodies and complex oxide nano particles manufactured by the method of manufacturing complex oxide nano particle; internal electrodes alternated with the dielectric layers; and external electrodes electrically connected to the internal electrodes respectively.

FIG. 2 is a cross-sectional view of an MLCC according to an exemplary embodiment of the present invention. The invention may however be embodied in many different forms and should not be construed as limited to the embodiments set forth herein.

Referring to FIG. 2, an MLCC 100 includes dielectric layers 102 and internal electrodes 101 and 103 that are alternately laminated. External electrodes 104 and 105 are electrically connected to corresponding internal electrodes 101 and 103, respectively.

The dielectric layers 102 each include a ceramic dielectric body and complex oxide nano particles manufactured according to the present invention. As for the ceramic dielectric body, barium (meta) titanate (BaTiO₃) may be used, but the present invention is not limited thereto. Complex oxide nano particles manufactured by a manufacturing method according to the present invention may have an average particle size of 60 nm or less, thus ensuring the super slim profiles of the dielectric layers 102 and the high capacity of a ceramic capacitor. As for a conductive material in the internal electrodes 101 and 103, Ni or a Ni alloy may be used since the dielectric layers 102 have environment-resistant properties, but the present invention is not limited thereto. A conductive material, contained in the external electrodes 104 and 105, may be InGa, Cu or Ni, but the present invention is not limited thereto.

The method of manufacturing an MLCC 100 according to this embodiment is not limited specifically, but may adopt a general method used in the art. For example, the MLCC 100 may be manufactured by molding green sheets by use of slurry containing a ceramic dielectric body and complex oxides as additives, printing internal electrodes in the green sheets, and sintering the green sheets.

### EMBODIMENTS

The present invention will now be described in more detail by use of embodiments and comparative examples, but the scope of the present invention is not limited to the following embodiments.

### Preparation of Complex Oxide

### Embodiment 1

Magnesium salt of 12.82 g, aluminum salt of 8.10 g, vanadium salt of 0.82 g, manganese salt of 2.88 g, barium salt of 10.45 g, and dysprosium salt of 19.30 g were dissolved in 232 g of water, thus preparing a metal-salt mixed solution. Thereafter, an organic polymer was impregnated with this metal-salt mixed solution and then dried in the air for 24 hours. After the process of drying, the temperature was raised to 400° C. at a heating rate of 5° C./minute and maintained for 2 hours, whereupon the temperature was raised again to 700° C. at a heating rate of 5° C./minute and maintained for 2 hours. Thereafter, cooling was performed to room temperature, thus manufacturing complex oxide nano particles.

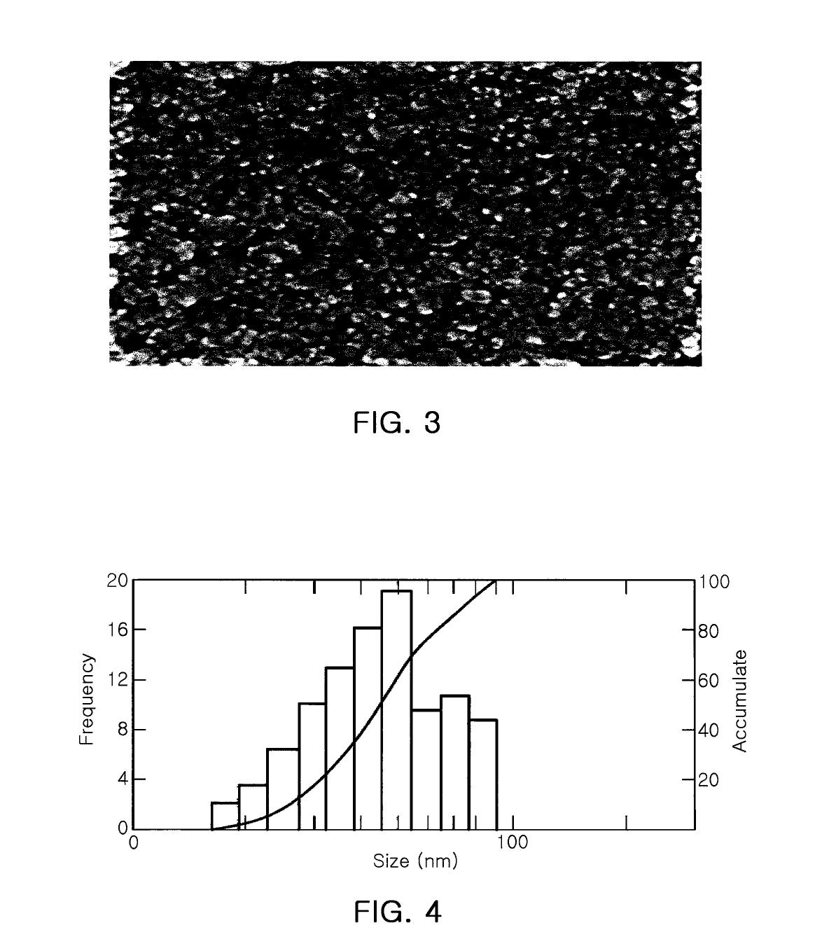

FIGS. 3 and 4 are a field emission scanning electron microscope (FE-SEM) image and a graph depicting the particle-size distribution of complex oxide nano particles manufactured by the embodiment 1, respectively. Referring to FIGS. 3 and 4, complex oxide nano particles manufactured according to an exemplary embodiment of the present invention have uniform shapes, and have an average particle size of about 50 nanometers. It can be seen that different kinds of metal oxide are divided and thus can act as separate nano particles.

### Comparative Example 1

The oxides of aluminum, manganese, barium, magnesium, vanadium and dysprosium were mixed according to a predetermined composition ratio, heated and then milled.

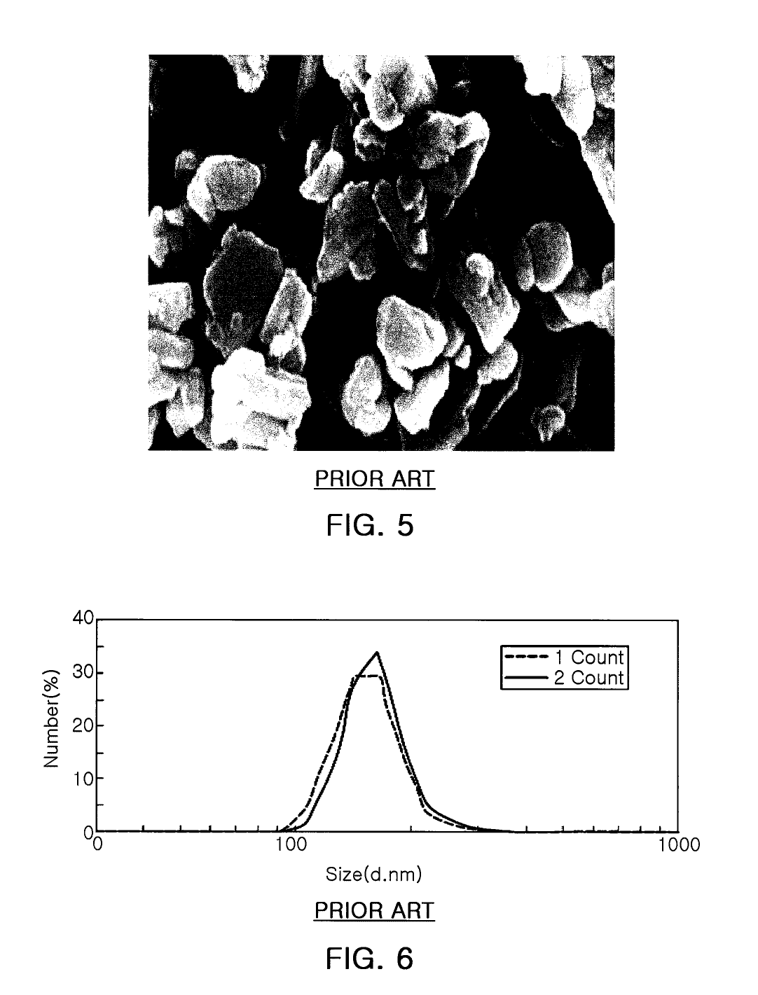

FIGS. 5 and 6 are an FE-SEM image and a graph depicting the result of particle-size analysis on metal oxide nano particles this comparative example, respectively. The analysis of particle size was performed twice on the same metal oxide nano particles, and the D₅₀ denoting the average size of accumulative particles (50%), was 157 nm.

### Manufacturing of a Ceramic Capacitor

### Embodiment 2

The complex oxides manufactured in the embodiment 1 and barium titanate were mixed and dispersed in an organic solvent. Thereafter, a resultant solution was mixed with an organic binder to produce a slurry which was applied on films, thereby manufacturing molding sheets. The manufactured molding sheets were laminated up to a thickness of about 1 mm. This laminate was subject to cold isostatic press (CIP) and cut into test pieces. The test pieces were heated at 400° C. for 4 hours or longer to remove the organic binder, dispersants and the like, and then sintered. InGa used for external electrodes was applied to the sintered test pieces and was subject to electrode firing at a temperature of 700° C. to 900° C., thus manufacturing end test pieces. Thereafter, the dielectric and electrical characteristics were estimated.

### Comparative Example 2

Test pieces were manufactured using the metal oxide manufactured by the comparative example 1 in the same manner as the embodiment 2, and then dielectric and electrical characteristics were estimated.

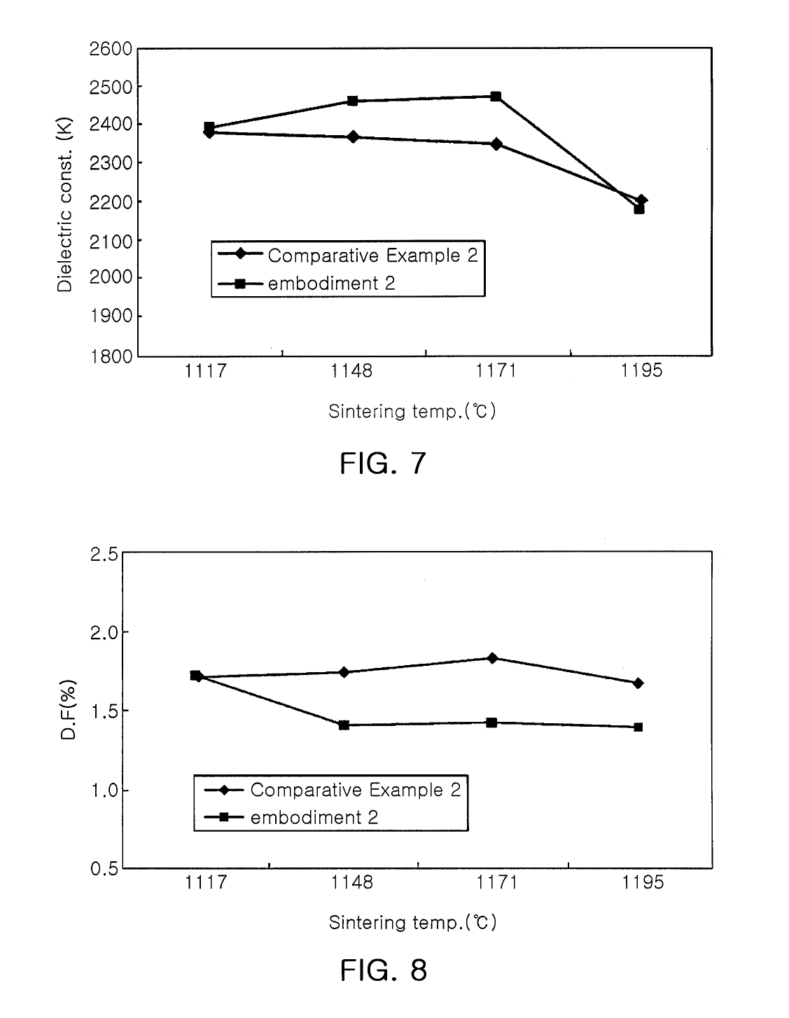

FIGS. 7 and 8 are graphs respectively depicting the dielectric constants and loss coefficients of the test pieces manufactured by the embodiment 2 and the comparative example 2. It can be seen from FIGS. 7 and 8 that the dielectric constants of the test pieces of the embodiment 2 are maintained at an equivalent level to the comparative example 2, and the loss coefficients of the embodiment 2 are maintained at a lower level than the comparative example 2.

As set forth above, according to exemplary embodiments of the invention, complex oxides with particle sizes in the nanoscale can be manufactured, and the kind and composition ratio of metal elements contained in the complex oxides can be easily controlled. Also, MLCCs employing the composite metal oxides manufactured by the above method can ensure super slim profiles and high capacities.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing complex oxide nano particles, the method comprising:
preparing a mixed solution including at least one metal salt selected from the group consisting of aluminum salt, manganese salt and barium salt;
impregnating an organic polymer having nano-sized pores with the mixed solution; and
calcining the organic polymer impregnated with the mixed solution.

2. The method of claim 1, wherein in the preparing of the mixed solution, the mixed solution further includes at least one metal salt selected from the group consisting of magnesium salt, vanadium salt and dysprosium salt.

3. The method of claim 1, wherein a solvent of the mixed solution is water or an organic solvent.

4. The method of claim 1, wherein the mixed solution has a concentration in the range of 5 wt % to 25 wt %.

5. The method of claim 1, wherein the pores of the organic polymer range from 1 nm to 9 nm in size.

6. The method of claim 1, wherein the calcining of the organic polymer is performed at a temperature ranging from 250° C. to 900° C.

7. The method of claim 1, wherein the calcining of the organic polymer is performed in two steps.

8. The method of claim 1, wherein the calcining of the organic polymer is performed at a temperature of 250° C. to 350° C., and then at a temperature of 700° C. to 900° C.

9. The method of claim 1, further comprising drying the organic polymer, before the calcining of the organic polymer impregnated with the mixed solution including the metal salt.

10. The method of claim 1, further comprising milling remnants after the calcining of the impregnated organic polymer.

11. Complex oxide nano particles manufactured by the method of claim 1.

12. A multilayer ceramic capacitor comprising:
a plurality of dielectric layers each including a ceramic dielectric body and the complex oxide nano particles of claim 11;
internal electrodes alternated with the dielectric layers; and
external electrode electrically connected to the internal electrode, respectively.
